(19) United States
(12) Patent Application Publication
(10) Pub. No.: US 2017/0114309 A1
(43) Pub. Date: Apr. 27, 2017

(54) Soap Remnant Recycling Assembly

(71) Applicant: Janice Hammond, Sherills Ford, NC (US)

(72) Inventor: Janice Hammond, Sherills Ford, NC (US)

(21) Appl. No.: 14/921,168

(22) Filed: Oct. 23, 2015

(51) Int. Cl. C11D 13/30; B02C 18/08; B02C 18/22; C11D 13/14; C11D 13/22

(52) U.S. Cl. CPC C11D 13/30; C11D 13/14; C11D 13/22; B02C 18/2291; B02C 18/08

(57) ABSTRACT

A soap remnant recycling assembly includes a housing that has a bottom wall, a top wall and a perimeter wall extending therebetween. The top wall has an opening extending therein and into an interior of the housing. A conduit is attached to the top wall and is in fluid communication with the opening. A funnel is attached to the conduit and extends upwardly therefrom. An access aperture extends through the perimeter wall and into the interior. A door is removably positioned in a closed position closing the access aperture or in an open position. A spindle is positioned within the conduit. The spindle has a plurality of blades attached thereto. A plate is mounted within the housing. The plate is movable toward or away from the door. The plate extends from the top wall to the bottom wall and from a first lateral wall to a second lateral wall.

### BACKGROUND OF THE DISCLOSURE

Field of the Disclosure

The disclosure relates to soap remnant utilization devices and more particularly pertains to a new soap remnant utilization device for combining a plurality of soap bar remnants into a new, single bar of soap.

### SUMMARY OF THE DISCLOSURE

An embodiment of the disclosure meets the needs presented above by generally comprising a housing that has a bottom wall, a top wall and a perimeter wall which is attached to and extends between the top and bottom walls. The top wall has an opening extending therein and into an interior of the housing. A conduit is attached to and extends upwardly from the top wall. The conduit is in fluid communication with the opening. A funnel is attached to the conduit and extends upwardly therefrom. An access aperture extends through the perimeter wall and into the interior. A door is removably positioned in a closed position closing the access aperture or in an open position. A spindle is positioned within the conduit. The spindle has a plurality of blades attached thereto. A plate is mounted within the housing. The plate is movable toward or away from the door. The plate extends from the top wall to the bottom wall and from a first lateral wall to a second lateral wall.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a soap remnant recycling assembly according to an embodiment of the disclosure.

FIG. 2 is a side view of an embodiment of the disclosure.

FIG. 3 is a top view of an embodiment of the disclosure.

FIG. 4 is a cross-sectional view of an embodiment of the disclosure taken along line 4-4 of FIG. 1.

FIG. 5 is a cross-sectional view of an embodiment of the disclosure taken along line 5-5 of FIG. 4.

### DESCRIPTION OF THE PREFERRED EMBODIMENT

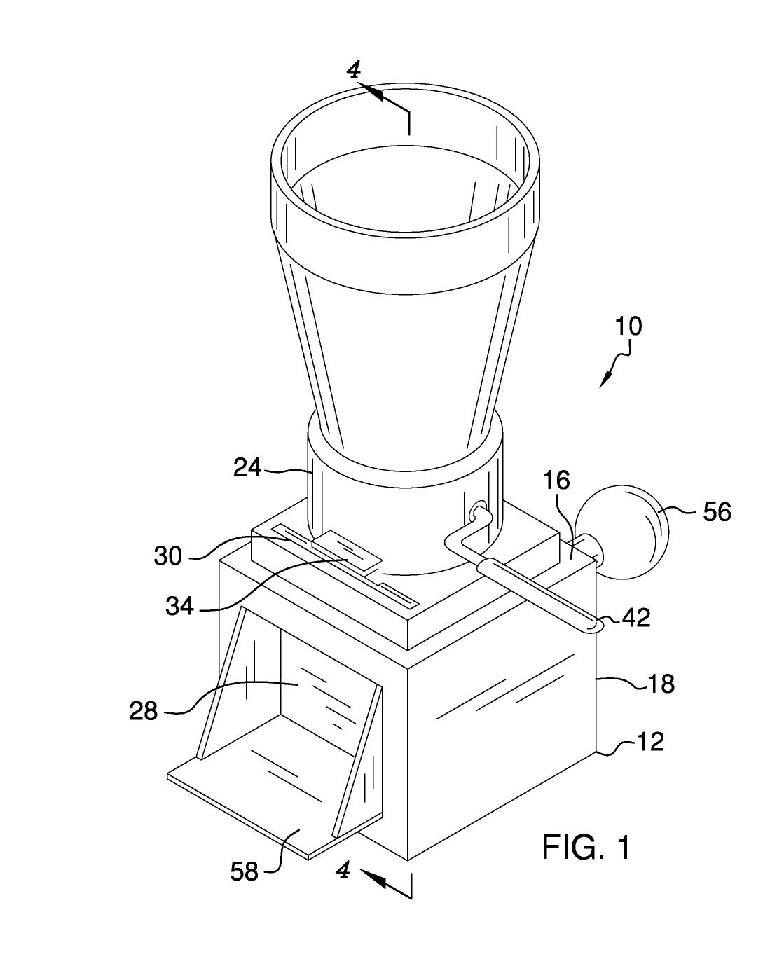

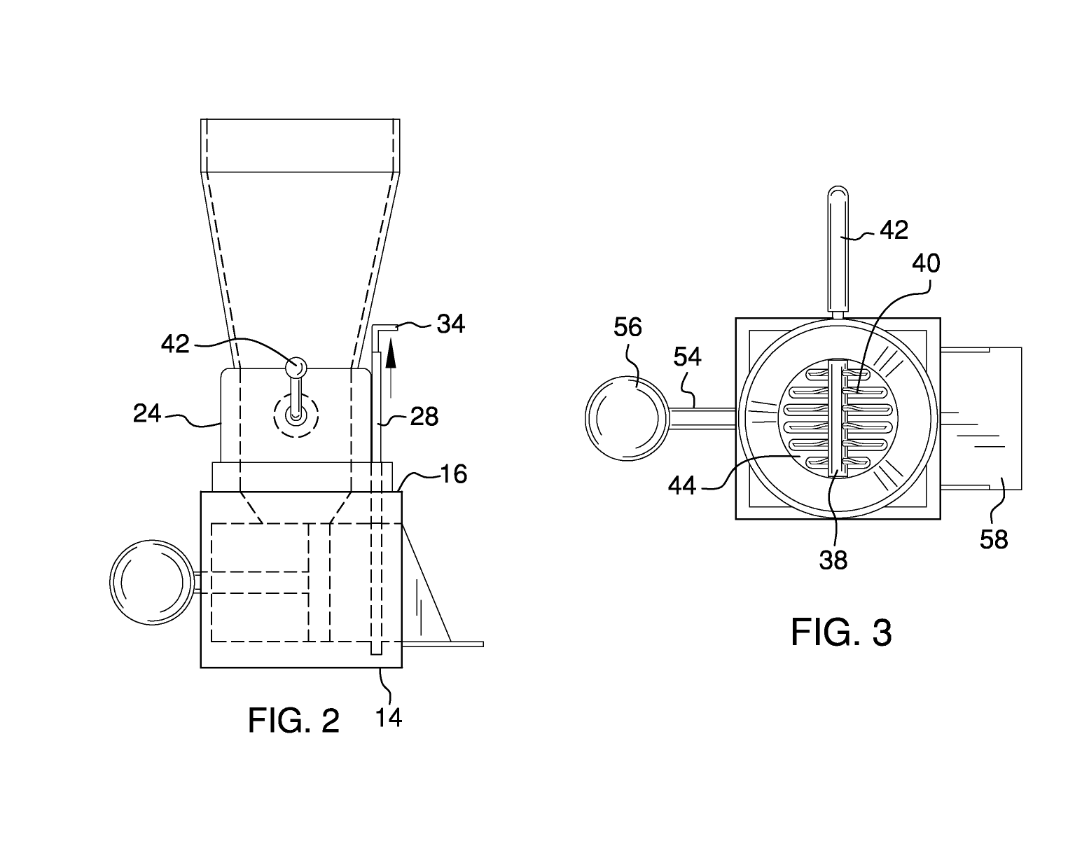

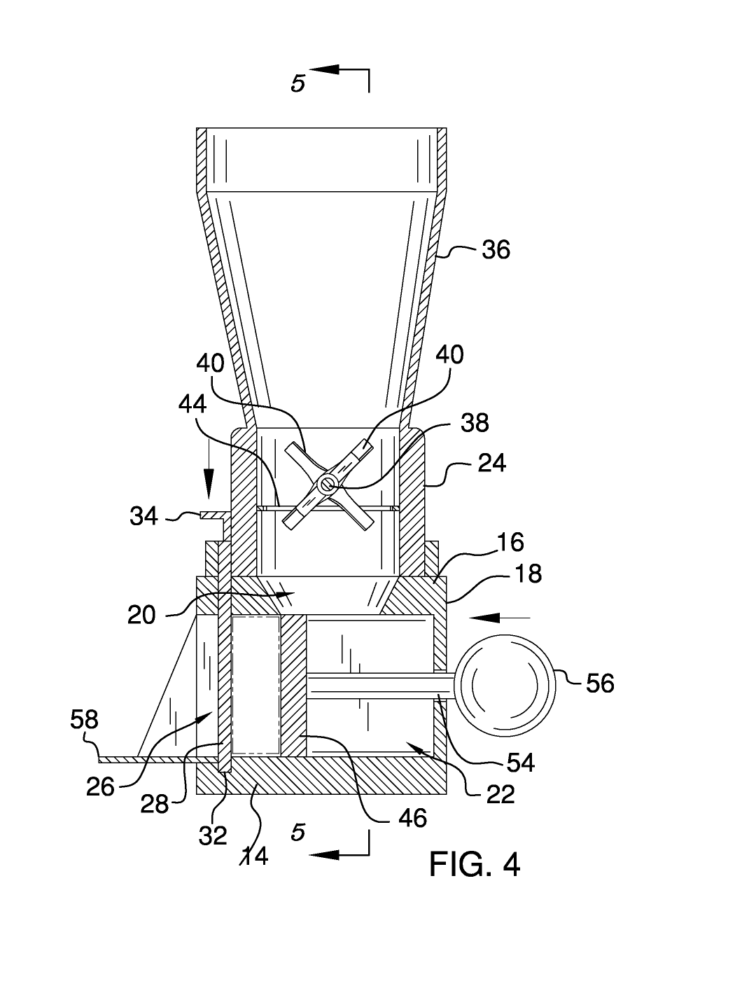

With reference now to the drawings, and in particular to FIGS. 1 through 5 thereof, a new soap remnant utilization device embodying the principles and concepts of an embodiment of the disclosure and generally designated by the reference numeral 10 will be described.

As best illustrated in FIGS. 1 through 5, the soap remnant recycling assembly 10 generally comprises a housing 12 that has a bottom wall 14, a top wall 16 and a perimeter wall 18 that is attached to and extends between the top 16 and bottom 14 walls. The housing 12 may have a height, length and width each between 3.0 inches and 5.0 inches. The top wall 16 has an opening 20 extending therein and into an interior 22 of the housing 12. A conduit 24 is attached to and extends upwardly from the top wall 16. The conduit 24 is in fluid communication with the opening 20. An access aperture 26 extends through the perimeter wall 18 and into the interior 22. A door 28 is removably positioned in a closed position closing the access aperture 26 or in an open position opening the access aperture 26. The door 28 may be configured to extend downwardly through a slot 30 in the top wall 16. The door 28 may further extend into a trough 32 in the bottom wall 14 and include a grip 34 for lifting or lowering the door 28 relative to the top wall 16.

A funnel 36 is attached to the conduit 24 and extends upwardly therefrom. The funnel 36 extends between 3.0 inches and 6.0 inches and widens as the funnel 36 extends upwardly from the conduit 24. A spindle 38 is positioned within the conduit 24. The spindle 38 has a plurality of blades 40 attached thereto which engage material as it is placed into the funnel 36. A handle 42 is attached to the spindle 38 and extends outwardly away from the conduit 24. The handle 42 is rotated to rotate the spindle 38. A grate 44 is mounted within the conduit 24 and the blades 40 extend through the grate 44. The grate 44 prevents material from falling by the blades 40 and into the interior 22 of the housing 12 before the material is ground by the blades 40.

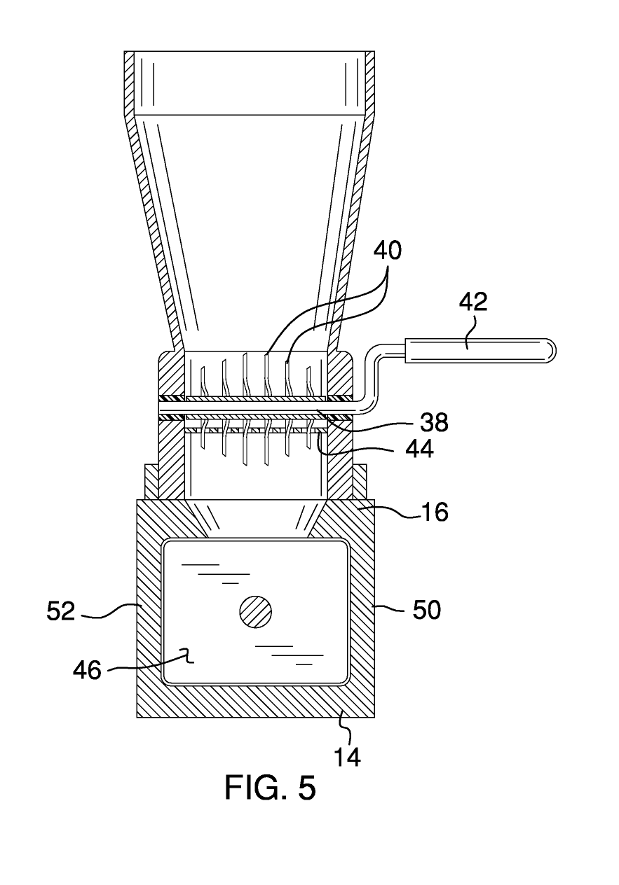

A plate 46 is mounted within the housing 12 and is movable toward or away from the door 28. As can be seen in FIG. 5, the plate 46 extends from the top wall 16 to the bottom wall 14 and from a first lateral wall 50 to a second lateral wall 52. The plate 46 may substantially form a seal with an inner surface of the interior 22 of the housing 12. A rod 54 is attached to the plate 46 and extends through the perimeter wall 18 opposite of the door 28. A knob 56 is attached to the rod distal to the plate to facilitate moving the plate 46 away from or towards the door 28. A catch 58 may be attached to the housing 12 adjacent to the bottom wall 14 and the access aperture 26 such that material may be caught that is pushed outwardly of the interior 22 by the plate 46 when the door 28 is open.

In use, remnants of bar soap are placed in the funnel 36 and the handle 42 turned to cause the blades 40 to grind the remnants into smaller pieces which fall through the grate 44 and into the interior 22 of the housing 12. Once the user has accumulated a desired amount of ground soap in the interior 22, the user may add a small quantity, such as less than ¼ cup, of warm or hot water to the interior 22 of the housing 12. The user then uses knob 56 to press the ground soap against the door 28 so that the ground soap forms into bar. The door 28 is then opened and the bar removed from the housing 12 to be used in a manner conventional to bars of soap.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A soap remnant shredding and soap bar forming assembly comprising:
a housing having a bottom wall, a top wall and a perimeter wall being attached to and extending between said top and bottom walls, said top wall having an opening extending therein and into an interior of said housing;
a conduit being attached to and extending upwardly from said top wall, said conduit being in fluid communication with said opening;
a funnel being attached to said conduit and extending upwardly therefrom;
an access aperture extending through said perimeter wall and into said interior;
a door being removably positioned in a closed position closing said access aperture or in an open position;
a spindle being positioned within said conduit, said spindle having a plurality of blades attached thereto; and
a plate being mounted within said housing, said plate being movable toward or away from said door, said plate extending from said top wall to said bottom wall and from a first lateral wall to a second lateral wall.

2. The soap remnant shredding and soap bar forming assembly according to claim 1, wherein said door extends downwardly through a slot in said top wall.

3. The soap remnant shredding and soap bar forming assembly according to claim 1, further including a handle being attached to said spindle and extending outwardly away from said conduit, said handle being rotated to rotate said spindle.

4. The soap remnant shredding and soap bar forming assembly according to claim 1, further including a grate being mounted within said conduit, said blades extending through said grate.

5. The soap remnant shredding and soap bar forming assembly according to claim 1, further including a rod being attached to said plate and extending through said perimeter wall, a knob being attached to said rod distal to said plate.

6. The soap remnant shredding and soap bar forming assembly according to claim 1, further including a catch being attached to said housing adjacent to said bottom wall and said access aperture.

7. A soap remnant shredding and soap bar forming assembly comprising:
a housing having a bottom wall, a top wall and a perimeter wall being attached to and extending between said top and bottom walls, said top wall having an opening extending therein and into an interior of said housing;
a conduit being attached to and extending upwardly from said top wall, said conduit being in fluid communication with said opening;
a funnel being attached to said conduit and extending upwardly therefrom;
an access aperture extending through said perimeter wall and into said interior;
a door being removably positioned in a closed position closing said access aperture or in an open position, said door extending downwardly through a slot in said top wall;
a spindle being positioned within said conduit, said spindle having a plurality of blades attached thereto, a handle being attached to said spindle and extending outwardly away from said conduit, said handle being rotated to rotate said spindle;
a grate being mounted within said conduit, said blades extending through said grate;
a plate being mounted within said housing, said plate being movable toward or away from said door, said plate extending from said top wall to said bottom wall and from a first lateral wall to a second lateral wall;
a rod being attached to said plate and extending through said perimeter wall, a knob being attached to said rod distal to said plate; and
a catch being attached to said housing adjacent to said bottom wall and said access aperture.
